(19) United States
(12) Patent Application Publication
(10) Pub. No.: US 2016/0368098 A1
(43) Pub. Date: Dec. 22, 2016

(54) METHOD OF MANUFACTURING ELECTRONIC COMPONENTS AND CORRESPONDING ELECTRONIC COMPONENT

(71) Applicant: STMicroelectronics (Malta) Ltd, Kirkop (MT)

(72) Inventors: Kenneth Fonk, San Gwann (MT); Kevin Formosa, Zabbar (MT)

(73) Assignee: STMicroelectronics (Malta) Ltd, Kirkop (MT)

(21) Appl. No.: 15/135,047

(22) Filed: Apr. 21, 2016

(30) Foreign Application Priority Data
Jun. 16, 2015 (IT) 102015000024379

(51) Int. Cl. B23K 26/359; B23K 26/351; B23K 26/00

(52) U.S. Cl. CPC B23K 26/359; B23K 26/0006; B23K 26/351

(57) ABSTRACT

An electronic component includes one or more circuits having a front surface and a light-permeable package material. A lid member is attached to a front surface of the circuit. The lid member is made, for example, of a light-blocking material such as a semiconductor or metal material. A laser marking is applied onto the lid member.

### PRIORITY CLAIM

This application claims priority from Italian Application for Patent No. 102015000024379 filed Jun. 16, 2015, the disclosure of which is incorporated by reference.

### TECHNICAL FIELD

The description relates to electronic components. One or more embodiments may apply to manufacturing electronic components such as e.g. integrated circuits (ICs).

### BACKGROUND

Marking, such as laser marking, may be applied to electronic components for various reasons such as e.g.: pin-1 indication, trace-ability, indicating manufacturing information such as e.g. manufacturer ID and plant ID, letting the component carry information of interest e.g. for the customer.

Marking applied to components with a transparent package may turn out to be hardly legible due e.g. to lack of contrast.

Also, electronic components with a transparent package may include light-sensitive circuitry. Protection from potentially harmful light radiation such as e.g. UV, IR and/or visible light radiation may be a desirable feature.

There is a need in the art to provide improvements in packages of electronic components along the lines discussed in the foregoing.

### SUMMARY

In an embodiment, a method of manufacturing electronic components including at least one circuit having a front surface and a light-permeable package for said at least one circuit is presented. The method includes: providing at said front surface of the circuit a lid member of light-blocking material, and applying a laser marking onto said light-blocking lid member.

In an embodiment, an electronic component includes: at least one circuit having a front surface with a light-permeable package on said at least one circuit, a lid member of light-blocking material applied onto said front surface, and a marking for said component, said marking located on said light-blocking lid member such that said marking is visible through said light-permeable package.

In an embodiment, a method comprises: attaching an integrated circuit chip to a die pad; connecting bonding wires from a top surface of the integrated circuit chip to a lead frame; attaching a bottom surface of a lid member to the top surface of the integrated circuit chip using an attachment means; laser marking a top surface of the lid member with information; and encapsulating the integrated circuit chip, bonding wires and lid member within a molded package material.

One or more embodiments may provide a solution for laser marking and circuit protection in electronic components including transparent packages, e.g. by means of a “bare” silicon lid (slab) applied e.g. via a die attach process.

One or more embodiments may provide a more robust solution for laser marking together with adequate circuit protection.

One or more embodiments may involve replacing “glob top” material as applied onto a circuit (for instance an ASIC) by means of a semiconductor or metal lid member. This may provide a marking platform on top (that is, at the front surface) of the component while also providing light-blocking properties.

One or more embodiments may result in a more conformal process which may turn out to be more stable in terms of conformal coating repeatability, while providing improved yield, device performance and productivity (Units Per Hour or UPH).

One or more embodiments may result in an increased top (that is, front surface) marking area for the component, so that an extended amount of data which may be carried by the component; reading such information from the component may be facilitated, possibly with the component (already) mounted on a support such as Printed Circuit Board (PCB).

### BRIEF DESCRIPTION OF THE DRAWINGS

One or more embodiments will now be described, by way of example only, with reference to the annexed figures, wherein:

FIG. 1 is a top plan view of an electronic component according to embodiments;

FIG. 2 is a cross sectional view along line II-II of FIG. 1; and

FIG. 3 is a functional flow diagram of steps in a method according to one or more embodiments.

### DETAILED DESCRIPTION

In the ensuing description one or more specific details are illustrated, aimed at providing an in-depth understanding of examples of embodiments. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments.

The references used herein are provided merely for convenience and hence do not define the extent of protection or the scope of the embodiments.

Various issues may arise in providing marking of electronic components, e.g. integrated circuits (ICs) such as Application Specific Integrated Circuits—ASICs.

Such marking may be top-side marking, that is marking of the top or upper (front) side of the IC, opposed to the substrate onto which the component is eventually mounted. A printed circuit board or PCB is exemplary of such a mounting substrate.

Laser marking is exemplary of a possible marking option. In laser marking, a laser beam may be focused directly onto the package top surface. Laser marking technology has been widely applied to conventional dark-resin molded packages. This effectively burns the resin top surface, creating discoloration so that a contrasting image creating a marking pattern may result.

Various components such as UV (ultra-violet) sensors, motion MEMS (Micro Electro-Mechanical Systems), environmental MEMS, various types of optical devices may include “transparent” packages, that is packages including a material permeable to light radiation, that is light radiation in the visible, UV or IR ranges.

In that respect, “glob top” conformal coverage of the circuit (e.g. ASIC) may be an option capable of dealing with height restrictions. A glob top material with light-blocking properties may be applied e.g. in the form of an epoxy glue to cover the underlying circuit. Applying such a glob top material may involve e.g. dispensing or jetting a light-blocking (e.g. opaque) material onto the light sensitive region of the top surface of the component.

Such an approach may exhibit various drawbacks/limitations, including e.g.: undesired shift in the glob top material, incomplete coverage of the light-sensitive circuit area to be protected, poor legibility of the marking due to lack of contrast of the marking area with respect to the surrounding transparent areas.

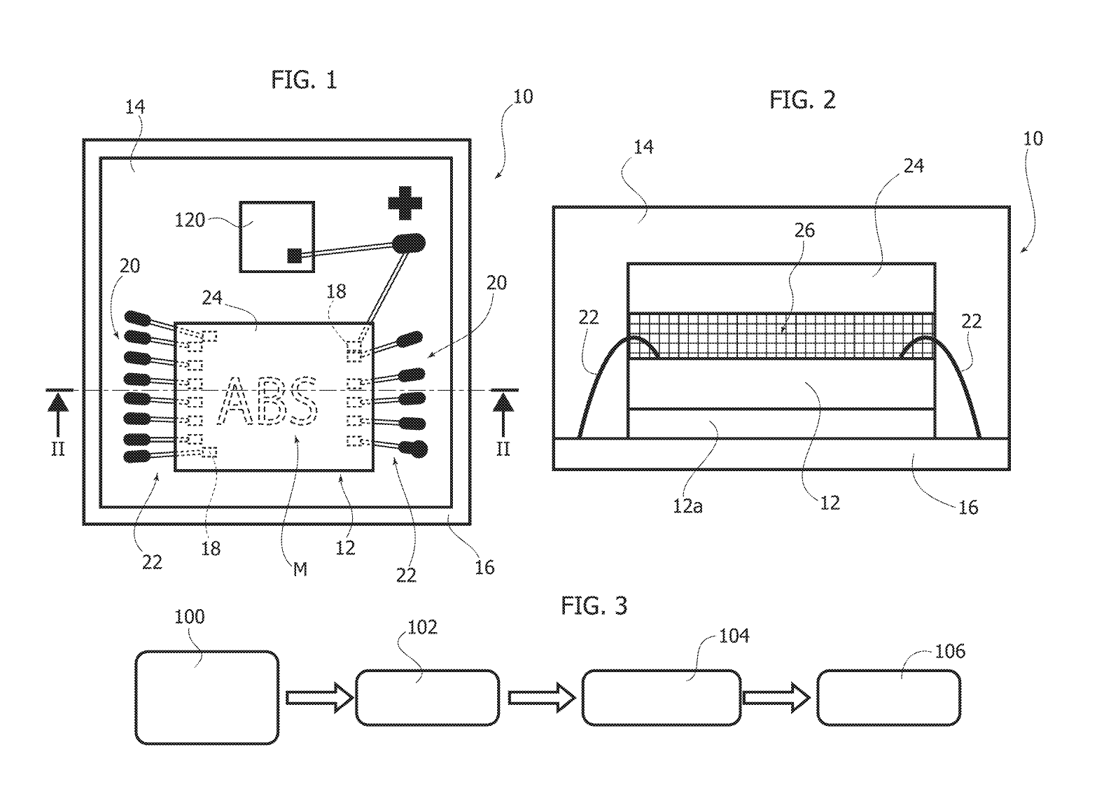

FIGS. 1 and 2 are exemplary views of an electronic component 10 including a circuit 12 such as e.g. a chip (or “die”). An Application Specific Integrated Circuit or ASIC may be exemplary of such a circuit.

In one or more embodiments the component may include a package 14 (e.g. a molding compound or MC).

In one or more embodiments, the package 14 may include a “light-permeable” material, that is a material which may be transparent to electromagnetic radiation in the visible, IR and/or UV ranges.

Such “transparent” package materials may include e.g. optical silicon resin encapsulants or transparent transfer molding compounds.

In one or more embodiments, the circuit (e.g. ASIC) 12 may be arranged on a die pad 16 by various means e.g. via solder material, glue or die attach tape (film), schematically indicated as 12a in FIG. 2.

In one or more embodiments, the die pad 16 may be located at the bottom surface of the package 14. In one or more embodiments the die pad 16 may not be provided.

Also, in one or more embodiments a component 10 may include a single circuit 12. In one or more embodiments as exemplified in the figures, the component 10 may include other elements, e.g. a MEMS 120 with the circuit 12 operatively connected thereto, possibly to provide associated processing functions .

Manufacturing processes of components such as the component 10 may involve e.g. mounting a die 12 (e.g. an ASIC) on a pad 16, connecting die pads 18 to pins 20 of the package with electrically conductive wires 22 connecting the pads 18 to the pins 20 which may form a so-called lead frame.

A component 10 as exemplified herein may then be mounted on a substrate such as a Printed Circuit Board or PCB (not visible in the figures). Connection of the die (e.g. ASIC) 12 to the “outside world” may be obtained by wire bonding and substrate routing between top metal and a bottom metal layer which may be provided e.g. by the Printed Circuit Board (PCB), the lead frame or other packaging material.

Manufacturing steps as discussed in the foregoing may take place according to conventional principles and criteria, thus making it unnecessary to provide more detail description herein.

At least notionally, the possibility would exist of providing a “bottom side” laser marking of the component 10.

This may be e.g. at the die pad 16, thus avoiding to interfere with the package (e.g. with a clear/transparent top layer) and the device optical performance.

Also, prior to mounting the component 10 on a substrate such as a PCB, the possibility would exist, e.g. at the customer side, of applying laser marking on a specific area of that substrate (e.g. a so-called land area or land plane on the mounting PCB).

These arrangements would have certain inherent disadvantages: for instance the marking would inevitably end up by being “masked” under the component 10 once this is mounted on a substrate such as a PCB.

Also, such arrangements would be unable to provide protection of the circuit 12 against ambient light (visible, IR and/or UV).

As indicated, the circuit 12 may be covered with a coating of a so-called “glob top” material having light-blocking properties.

A disadvantage of this arrangement, possibly in addition to others, may lie e.g. in that a glob-top material may not be adapted for laser marking.

In one or more embodiments a lid member 24 e.g. a light-blocking layer of light-impermeable semiconductor or metal, may replace such a glob-top material on top of the circuit (e.g. ASIC) 12.

As used herein, a lid member will denote any (small) plate of material applied onto the circuit 12 and adapted to provide a “platform” for laser marking, while also possibly forming a light-blocking protective cover for at least one part of the circuit 12.

In one or more embodiments, the lid member 24 may include a “bare” lid or slab of a semiconductor material, e.g. silicon, or metal e.g. copper or aluminum, which may have good oxidizing properties.

In one or more embodiments, the lid member 24 may be attached to the top side (that is, the front surface) of the circuit 12 by using a attach process such as a die attach process. Film On Wire (FOW) technology may be exemplary of such a process.

Such lid member 24 may provide both radiation (visible, IR and UV) blocking properties while also forming a marking platform for a laser marking.

The functional flow chart of FIG. 3 is exemplary of a sequence of steps in one or more embodiments.

In the flow chart of FIG. 3, the block 100 denotes the completion of the various steps (known per se) which lead to completing the full internal package assembly of the component 10 up to stage where the lid member 24 (e.g. a bare silicon wafer) is arranged on top of the circuit 12.

In one or more embodiments, this may involve mounting (and possibly dicing) the lid member 24 onto a FOW tape 26 so that the lid member 24 is die-attached onto the wire bonded connections 22 of the circuit 12.

In a step 102, laser marking may take place (in a manner known per se) to indicate data as desired (trace-ability, manufacturer ID and plant ID, etc.) on top of the lid member 24.

Such marking M may include lettering (e.g. A B S as exemplified in FIG. 1), numbers, symbols or any indicia which may be applied e.g. during the step 102 in the chart of FIG. 3.

In one or more embodiments, the manufacturing process of a component 10 may continue with a molding step 104 of a package 14 onto the rest of the component.

The package 14 may include any material which is permeable (transparent) to visible, IR and/or UV radiation: a blocking action of such radiation is in fact performed by the lid member 24.

Also, in one or more embodiments, a marking M laser-marked onto the light-blocking lid member 24 will be visible through the light-permeable package 14.

Subsequent steps such as PMC processing, singulation and so on may follow as generally indicated by the block 106.

In one or more embodiments, the component 10 with the marking M applied onto the “platform” 24 will also exhibit a protective, light-blocking feature of light-sensitive portions of the circuit 12 as desired: it will be appreciated that the protection effect of the platform 24 may in fact be limited to certain light/IR/UV sensitive portions of the component 10.

Possible advantages of one or more embodiments may include the following.

Providing a marking platform by using e.g. a lid member 24 applied through a die attach process may lead to a more conformal process which may also be more stable in terms of conformal coating repeatability, yield, device performance and UPH.

The marking area available may be increased appreciably. For instance, in a component 10 admitting a bottom marking area of 1.0×0.95 mm, a top marking area (platform 24) may be achieved of 2.1×1.3 mm.

In one or more embodiments this may make it possible to move from a limited marking capability (e.g. three characters) to the possibility to apply a data matrix substantially in excess of three characters.

Also, the top side marking capability of the semiconductor platform 24 may make it possible for the marking to be read even when the component 10 is mounted e.g. on a PCB.

A process sequence as exemplified in FIG. 3 may make it possible to apply marking (step 102) after assembly (step 100)—and not before die attach—so that the component may carry data more relevant to the specific assembly process.

One or more embodiments may provide naked-eye legibility of the marking (possibly after package molding—step 104 of FIG. 3) by means of automated standard scanning equipment.

Testing performed by the Applicant indicated that the embodiments will not affect performance of the circuit 12 (e.g. a UV sensor) within the scope of thermal ageing processes, with a so-called split difference found to be less than the error introduced by a bench tester.

Without prejudice to the underlying principles, the details and the embodiments may vary, even significantly, with respect to what has been described by way of example only, without departing from the extent of protection.

1. A method of manufacturing electronic components including at least one circuit having a front surface and a light-permeable package for said at least one circuit, the method including:
providing at said front surface of the circuit a lid member of light-blocking material, and
applying a laser marking onto said light-blocking lid member.

2. The method of claim 1, wherein said light-blocking lid member comprises a semiconductor material.

3. The method of claim 1, wherein said light-blocking lid member comprises a metal material.

4. The method of claim 1, wherein said light-blocking lid member comprises a material impermeable to visible, IR or UV light.

5. The method of claim 1, further including providing said light-blocking material lid member by a die attach process.

6. The method of claim 5, wherein the die attach process uses a Film-On-Wire technology.

7. The method of claim 1, further including molding said light-permeable package onto said at least one circuit with said light-blocking lid member provided at said front surface.

8. The method of claim 1, further including providing said light-permeable package onto said at least one circuit after applying said laser marking onto said light-blocking lid member.

9. An electronic component, including:
at least one circuit having a front surface with a light-permeable package on said at least one circuit,
a lid member of light-blocking material applied onto said front surface, and
a marking for said component, said marking located on said light-blocking lid member such that said marking is visible through said light-permeable package.

10. The electronic component of claim 9, wherein said light-blocking lid member is made of a semiconductor material.

11. The electronic component of claim 9, wherein said light-blocking lid member is made of a metal material.

12. A method, comprising:
attaching an integrated circuit chip to a die pad;
connecting bonding wires from a top surface of the integrated circuit chip to a lead frame;
attaching a bottom surface of a lid member to the top surface of the integrated circuit chip using an attachment means;
laser marking a top surface of the lid member with information; and
encapsulating the integrated circuit chip, bonding wires and lid member within a molded package material.

13. The method of claim 12, wherein the molded package material is transparent permitting viewing of the information from the laser marking.

14. The method of claim 12, wherein the lid member is light blocking.

15. The method of claim 14, wherein said light-blocking lid member comprises a semiconductor material.

16. The method of claim 14, wherein said light-blocking lid member comprises a metal material.
